(19) United States
(12) Patent Application Publication
(10) Pub. No.: US 2006/0080292 A1
(43) Pub. Date: Apr. 13, 2006

(54) Enhanced interface utility for web-based searching

(76) Inventor: Faisal Saud Mohammed Alanzi, Riyadh (AE)

Correspondence Address: PILLSBURY WINTHROP SHAW PITTMAN LLP, 1650 TYSONS BOULEVARD, MCLEAN, VA, 22102, US

(21) Appl. No.: 11/010,295

(22) Filed: Dec. 14, 2004

Related U.S. Application Data
(60) Provisional application No. 60/616,641, filed on Oct. 8, 2004.

(51) Int. Cl. G06F 17/30

(52) U.S. Cl. 707/3

(57) ABSTRACT

A method for searching the world wide web. The method includes receiving one or more keywords for a search and executing a search of the world wide web based on the one or more keywords to identify one or more web pages relevant to one or more keywords. Text versions of the web pages are created by removing images from the web pages. The method includes providing access to the text version of the web pages and displaying the text version of one of the web pages. The method may be used to create tabbed pages for image retrieval. A server and utility interface for implementing the search are also provided.

This application claims the benefit of U.S. Provisional Application No. 60/616,641 filed Oct. 8, 2004, which is herein incorporated by reference in its entirety.

### BACKGROUND

1. Field of the Invention

The present invention relates generally to an interface utility for web-based searching having several components that taken alone or in combination can enhance the speed and functionality of web-based searching. More particularly, the present invention relates to a TEXTSHOT view component, a tabbed paging component, a “web-based as you type real time spelling and keywords recommender” component, and a search toolbar component.

2. Background of the Invention

Generally, web-based search engines offer the capacity to search information available on the websites registered on the World Wide Web. The search results are displayed with a link to the respective websites along with a small pick of the text from the websites' relevant page, typically called a snippet. To find out if any of the website links from the search results do or do not contain desired information, a user must open each website from the links in the search results. This inefficient approach takes additional time as each web page is displayed. In addition, only after the search is performed will a conventional browser suggest other search terms.

### BRIEF SUMMARY OF THE INVENTION

TEXTSHOT view, tabbed paging,” and “web-based as you type real time spelling and keywords recommender” are components of an exemplary enhanced interface utility designed for web-based search engines, according to embodiments of the present invention. With these components in the enhanced interface utility, users can search the information on the Internet in a much quicker way than available with any of the present web-based search engine interfaces. The speed of viewing the search results from a search engine is substantially increased when searches are made using the TEXTSHOT viewer interface because users are not required to open the actual websites through the links in the search results; rather, the same can be viewed in fractions of seconds from within the original search results window. Likewise, using the tabbed paging component and the “web-based as you type real time spelling and keywords recommender” component of the interface, the overall efficiency, ease of use and speed in performing a web-based search is substantially improved as compared to traditional search engines.

The present invention involves tools that make the generation and viewing of web-based search results faster than traditional methods. These tools make it possible to spell check and correct the search keywords on the fly, then make it very convenient and fast to view the search results by generating TEXTSHOT views of the search results, and finally also make surfing through the entire set of search results (keeping in mind that an average web-based search through online search engines could generate hundreds and hundreds of search results) instantaneous and convenient by use of tabbing the entire search results from a single web page and loading the results for the next set of tabs asynchronously in the background, so when user clicks on new tab he sees instantly the search results along with their TEXTSHOT views. A TEXTSHOT view is a stripped down copy of the original web page, containing all of its visible text and its basic HTML formatting, such as color, fonts, style, and tables, but without the images, scripts, multimedia, plug-ins, and other additional tags. As a result, it is a text copy of that page, but smaller and quicker to load.

The “web-based as you type spelling and keywords recommender” (hereinafter “spelling and keywords recommender”) component of the invention is targeted at facilitating the user making a web-based search and also saving the time that is normally spent in spell checking the keywords that the user types in the search field. By the virtue of this component, the spell check automatically and instantly starts as the user types in the very first word, and instantly displays, in real time, the recommended word or string of words, which the user can then simply click on to correct the keywords. For the conventional technologies in the same field, the spellchecker utilities do not work on the fly and do not give instant recommendations or corrections. Rather, these conventional technologies are capable only of displaying the same once the search results window opens and a new web page is opened.

Using the “spelling and keywords recommender” component, the users can correct their mistakes before even actually beginning the search and save the time that would be consumed while another web page opens and shows a spell checked recommendation. Then, as the correct keywords are entered for the search and the search is conducted, the TEXTSHOT view component becomes available and offers the capability to quickly or instantly view a stripped down version (i.e., the text based content, without images and multimedia) of the actual websites that displays content related to the search being made, along with a view showing search results.

Using this component, the TEXTSHOT view as well as the view showing search results are both viewable from the same original web browser window in two different defined areas of the same search results web page. Hence, the user need not spend time opening the links in the search results in new browser windows or new web pages to find out if any particular link does or does not contain the information the user is seeking. Then lastly, at the same time, another component of the invention, the tabbed paging component, provides the means for displaying all the web-search results through a single web page in a single browser window.

In conventional web-based search engines, a user can only see a limited number of search results on a single web page, and to see the next batch of the search results, a user would need to open another web page, which is time consuming. In the present invention, the search result pages are all instantly tabbed at the bottom of the browser window. The user can instantly view both a search result display as well as the TEXTSHOT view of the search results for any and all of the search result web pages by clicking on the numbered tabs without having to open another web page or browser window. In addition, a user can move backward/forward among the tabs without having to load or reload the content of any of the tabbed pages again, as the same are instantly available from the cache. The tabbed paging can also be used to display images, news, blogs, and shopping results. For example, when an image search is performed, the tabbed pages can display a number of thumbnails.

A tool bar component can be downloaded on to a user's computer or network that allows a user to decide between textual web-based searching or image searching. This tool bar is launched whenever the user opens a web-browser and allows a user access directly to all of the other functions described above without having to go to a specific host web-page. The tool bar component offers data compression that allows information returned by a search to be quickly returned to the user. This is particularly helpful for those users that use a dial-up connection to the Internet, but can be used by any web-browser and with any connection speed.

Each of the components of the enhanced utility interface can be used together in combination or as stand-alone components.

### BRIEF DESCRIPTION OF THE DRAWINGS

FIG. 1 is a screen shot of an enhanced interface utility according an exemplary embodiment of the present invention.

FIG. 2 is a schematic diagram of an exemplary architecture implementing a TEXTSHOT view component of the enhanced interface utility according to an embodiment of the present invention.

FIG. 3 is an exemplary data flow diagram for the TEXTSHOT view component of FIG. 2.

FIG. 4 is a schematic diagram of an exemplary spelling and keywords recommender component architecture according to an embodiment of the present invention.

FIG. 5 is an exemplary data flow diagram for the spelling and keywords recommender component of FIG. 4.

FIG. 6 is an exemplary screen shot showing the results of implementing the spelling and keywords recommender component of FIGS. 4 and 5.

FIG. 7 is a schematic diagram of an exemplary tabbed paging architecture according to an embodiment of the present invention.

FIG. 8 is an exemplary data flow diagram for the tabbed paging component of FIG. 7.

FIGS. 9A and 9B show exemplary web page layouts using the TEXTSHOT view and tabbed paging components and FIGS. 9C and 9D are exemplary screen shots of FIG. 9A.

FIG. 10 is a schematic diagram of an exemplary tabbed paging architecture for image searching according to an embodiment of the present invention.

FIG. 11 is an exemplary data flow diagram for the tabbed paging component of FIG. 10.

FIG. 12 is a screen shot of a search toolbar configured to work with the enhanced utility interface of the present invention.

FIG. 13 is a schematic diagram of an exemplary search toolbar architecture for compressing data according to an embodiment of the present invention.

FIG. 14 is an exemplary data flow diagram for the compression of data of FIG. 13.

FIG. 15 is a schematic diagram of an exemplary search toolbar for providing a spelling and keywords recommender component according to an embodiment of the present invention.

FIG. 16 is an exemplary data flow diagram for the spelling and keywords recommender component of the search toolbar of FIG. 15.

FIGS. 17A and 17B are exemplary screen shots showing image results using the tabbed paging of FIGS. 10 and 11.

### DETAILED DESCRIPTION OF THE INVENTION

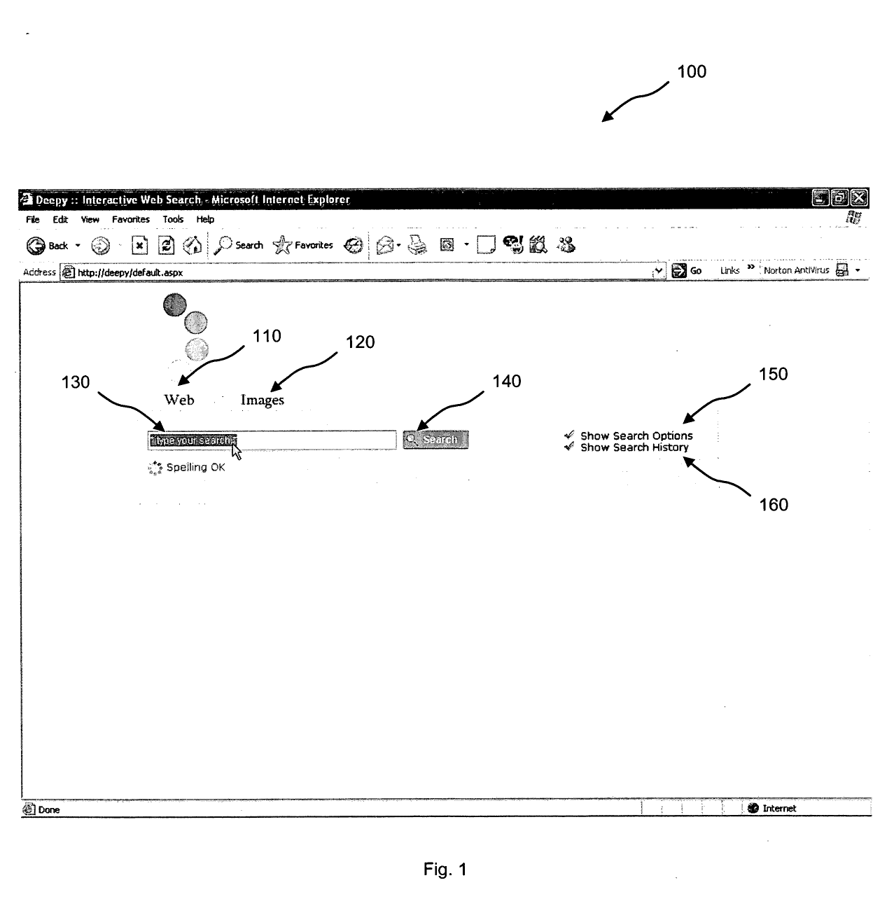

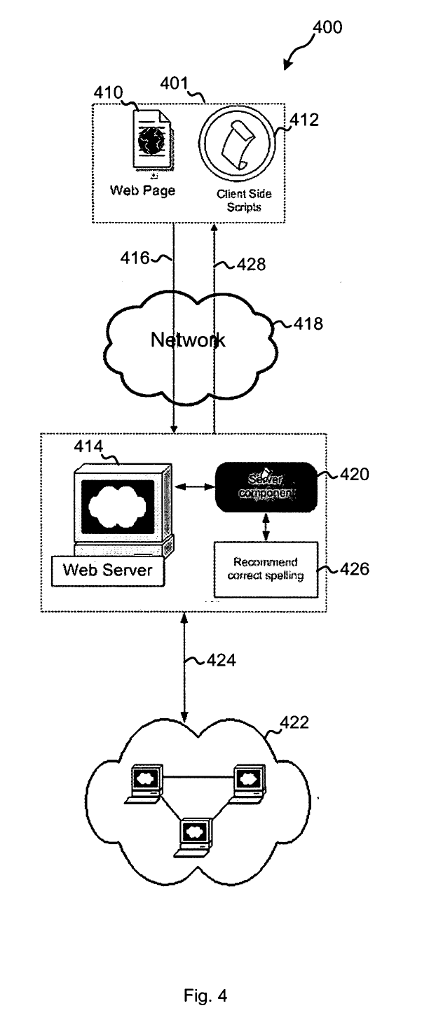

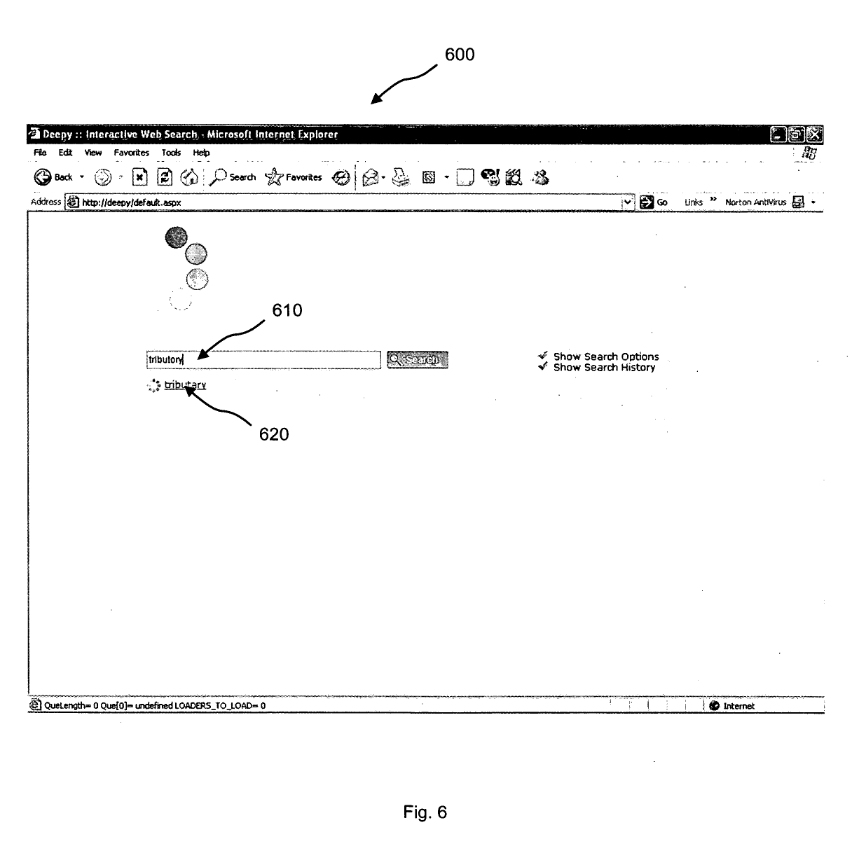

An exemplary screen shot 100 of an enhanced interface utility 100 is shown in FIG. 1. As shown, a user may perform a web-based search or limit the search to just images by selecting the web tab 110 or the image tab 120. A search input field 130 is provided that allows the user to input keywords to be searched using the enhanced interface utility. When the user is ready to perform the search, the user can click on search 140 button. One component of the enhanced interface utility, the spelling and keywords recommender component, may be activated once the user begins typing several characters of a keyword, after a space is entered, or after a specified period of time has elapsed. The result of the spelling and keywords recommender component may be seen in FIG. 6 and will be described in greater detail below with respect to FIGS. 4-6.

As shown in FIG. 1, the user has the ability to choose different search options by clicking the “show search options” link 150, which opens the advanced search options on the same page (in new layer) instantly without having to open a new page. The search options may include, but are not limited to, all of these words, this exact phrase, any of these words, none of these words, restrict to this site, restrict to this URL, and pages that link to this URL. These search options can be hidden. In addition, the user can see the previous search history by selecting “show search history” link 160, which opens the previous search history on the same page (in new layer) instantly without having to open a new page The previous search terms may have been stored on the user's computer or network. The search history may be associated with the specific search performed (i.e., web searches and image searches).

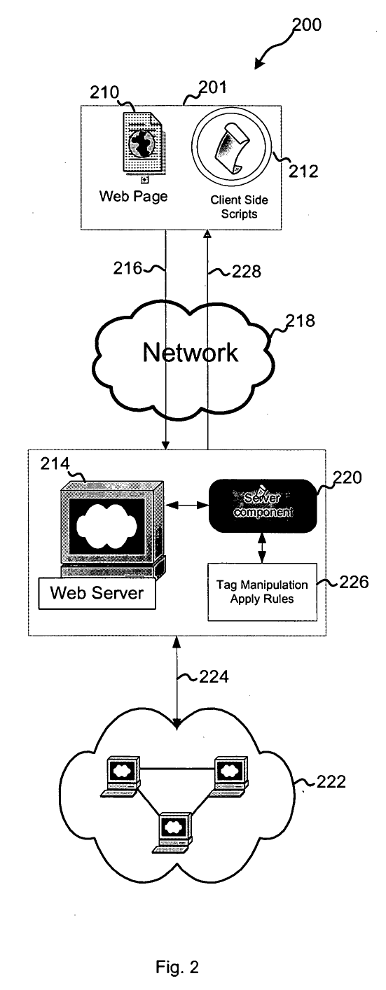

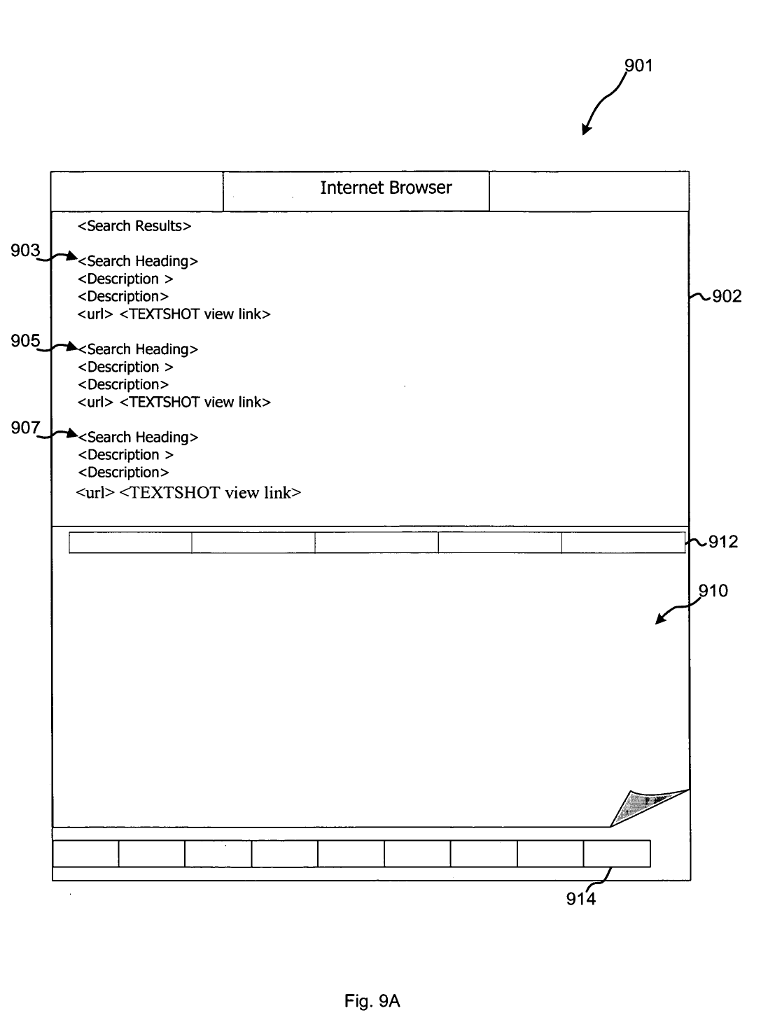

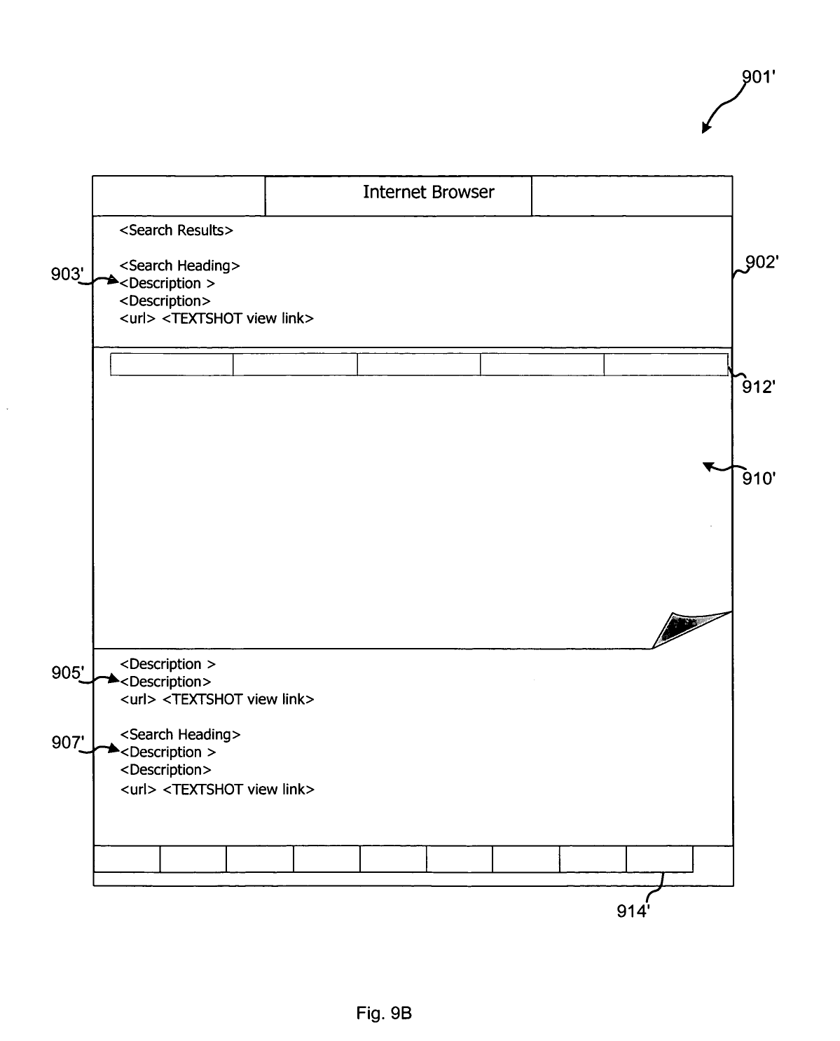

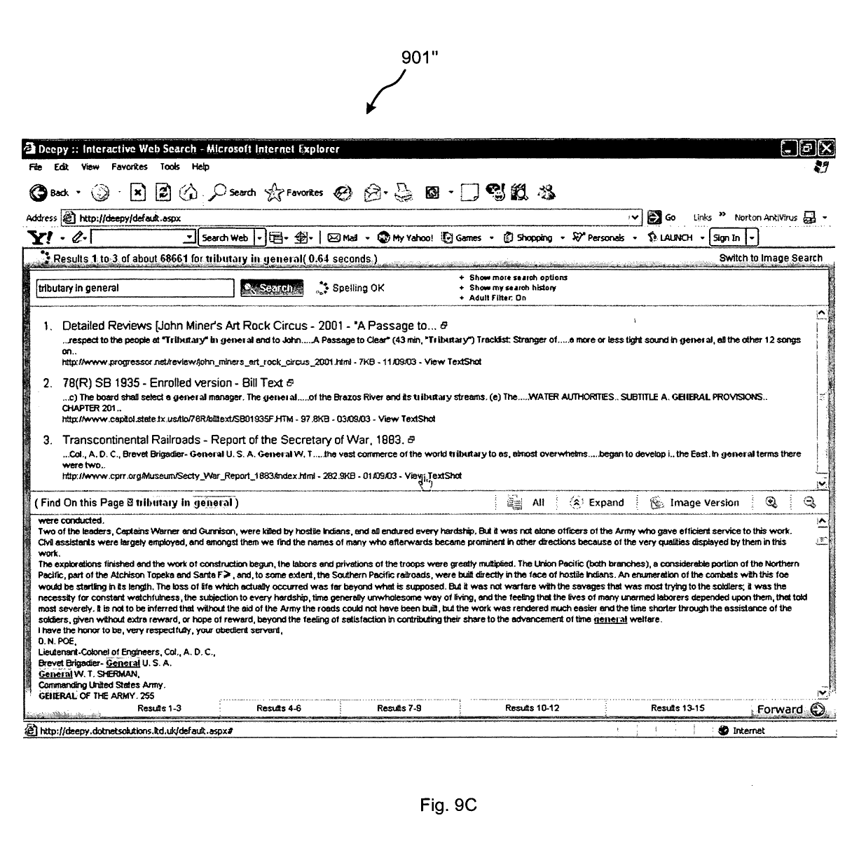

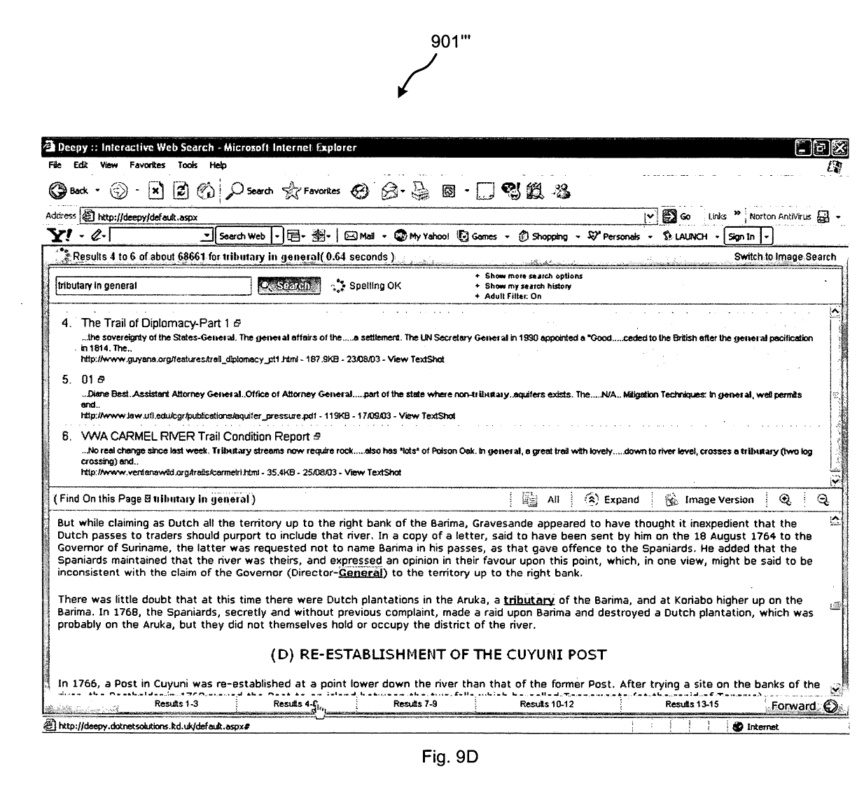

After the user enters the keywords and performs the search, a search result page is displayed. FIGS. 9C and 9D are screen shots 901″ and 901′″ of an exemplary search result page that shows the results of the TEXTSHOT view component and the tabbed paging component of the enhanced interface utility. The implementation of these components will be described with respect to FIGS. 2, 3, and 7-9C below.

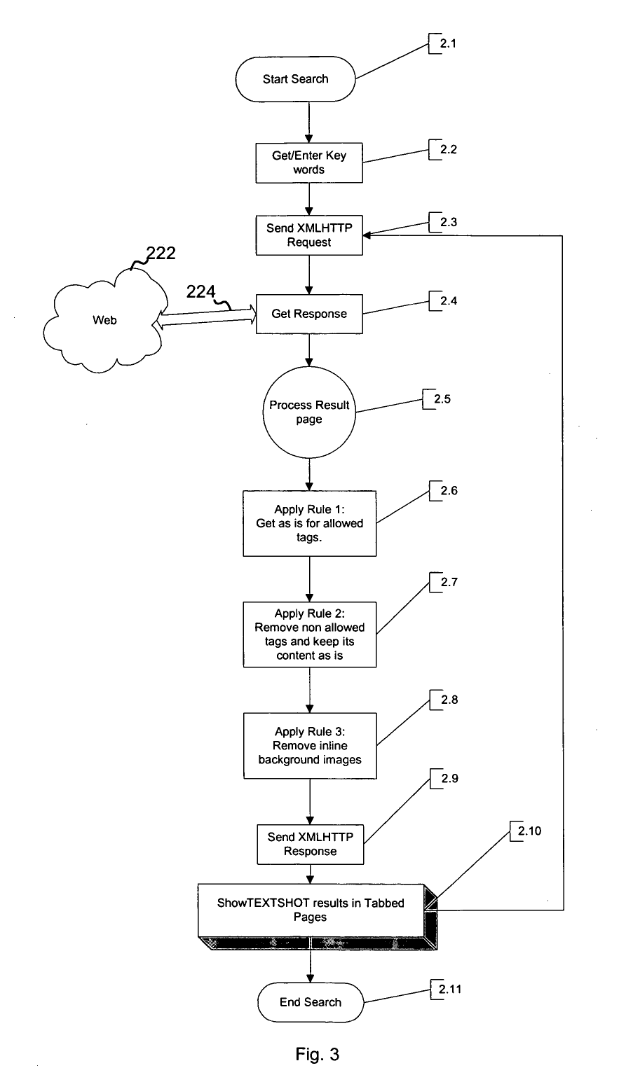

One exemplary embodiment of an enhanced interface utility 200 is shown in FIG. 2. Generally, in the embodiment shown, TEXTSHOT views of the search results are returned. A TEXTSHOT view is a stripped down version of web pages returned in web-based search results where images have been removed. When the user conducts a keyword based search through the search interface which holds the TEXTSHOT viewer interface, the TEXTSHOT system requests a copy of the actual page, either from the original website, databases stored on the web server, or another search engine database or cache. Then, some specific scripts in the TEXTSHOT server process the pages retrieved and perform tag manipulations using regular expressions, with the formula described below with respect to FIG. 3, in order to generate a new page called the TEXTSHOT view of the respective web page. FIGS. 9A and 9B show different embodiments for presenting the TEXTSHOT view results and FIG. 9C shows an exemplary screen shot 901″ of the search results page.

In this exemplary embodiment, as shown in FIG. 2, a user launches a web-browser from his computer 201 and navigates to a web page 210 to begin searching. The user types the desired keyword for the search and presses ‘Enter’ to begin the search. A client-side JavaScript event 212 is triggered to invoke the function to start the search from a server 214 using XMLHTTP Protocol over a network 218. Specifically, a XMLHTTP request 216 is transmitted over the network 218, such as the Internet, to server 214.

The server 214 queries its database 220 or external search engines 222 using HTTP Protocols 224, collects the search results, applies rules and tag manipulation 226, and then returns the results to the web browser 210 using an XMLHTTP Response 228. The rules and tag manipulations will be described further with regard to FIGS. 3, 9A, and 9B.

The search results are displayed as original search results in the web page 210, and again using a JavaScript 215, an asynchronous call is made (in the background) for each result to retrieve the TEXTSHOT view from the server 214 as it is selected by the user. The web page 210 may default to showing a TEXTSHOT view of the first link listed on the web page, when the TEXTSHOT is displayed in the browser. The TEXTSHOT view scrolls directly and automatically to the first word or phrase searched for by the user and may add background color to that word to distinguish it from the rest of the page text. The background coloring order of the searched keywords may be set as follows:
1st Keyword: FFFF66;
2nd Keyword: AOFFFF;
3rd Keyword: 99FF99;
4th Keyword: FF9999;
5th Keyword: FF66FF;
6th Keyword: 880000;
7th Keyword: 00M00;
8th Keyword: 886800;
9th Keyword: 004699;
10th Keyword: 990099.

FIG. 3 shows an exemplary embodiment of the data flow for implementing the TEXTSHOT view component. First, a user starts the search using an web browser at step 3.1. Next, at step 3.2, the user types the keywords for the search.

The enhanced interface utility sends the request to the server over the Internet, asynchronously, using XMLHTTP protocol at step 3.3. At step 3.4, the server script component queries its database or sends a request 224 to a search engine 222 using HTTP Protocol. The returned results are collected and one or more rules are applied to the search results at step 3.5.

At step 3.6, a first rule is applied where all tags other than those tags in a predefined list of allowed tags and those tags associated with a second rule are removed. For example, the predefined list of tags may include <td>, <tr>, <table>, <tbody>, <center>, <body>, <font>, <html>, <style>, <span>, <br>, <div>, <head>, <title>, <a>, <hr>, <meta>, <p>, <b>, <h1>, <h2>, <h3>, <h4>, <h5>, <h6>, <ol>, <ul>, <li>, <dl>, <menu>, <dt>, <dd>, and <u>, <legend><em>, <strong>, <dfn>, <code>, <samp>, <kbd>, <var>, <cite>, <tt>, <big>, <small>, <blockquote>, <caption>, <del>, <ins>, <PRE>, <q>, <s>, <strike>, <sub>, <sup>, <acronym>, <abbr>, <i>, <spacer>, <link>. Generally, these tags define basic formatting and may contribute to creating the TEXTSHOT view. In addition, these tags may include text that should be kept and displayed in the TEXTSHOT view.

At step 3.7, the second rule is applied. The second rule determines if any of the tags associated with the second rule are located, and if so, the tags are removed, but the content inside the start and end of each tag is retained. Exemplary tags associated with the second rule may include <form>, <option>, <textarea>, <button>, <fieldset>, <address>, <bdo>, <label>, <marquee>, <BASEFONT>, <BLINK>, and <layer> Generally these tags describe how the text is to be presented, but are unnecessary for purposes of a TEXTSHOT view.

A third rule is applied at step 3.8 to remove images. This third rule scans the attributes of the tags for background images and removes any background images. Exemplary tags include <table>, <td>, <body>, and <div>. If the tag <a> has an image, then the image is removed and replaced with the title text as a link for the image.

After one or more of the first, second, and third rule have been applied, the resulting content is sent back using an XMLHTTP call from the browser at step 3.9. Finally, at step 3.10, the results are displayed as tabbed pages and steps 3.3 to 3.9 are repeated for the next item in the search. It is understood that the search results could also be returned as a list of results without tabbing.

Finally, at step 3.11, the system exits the search. The system does this after reaching a fixed number of results, for example 50 results or 200 results, or if there are no more results. It is understood that this fixed number could be higher or lower to control the number of results returned.

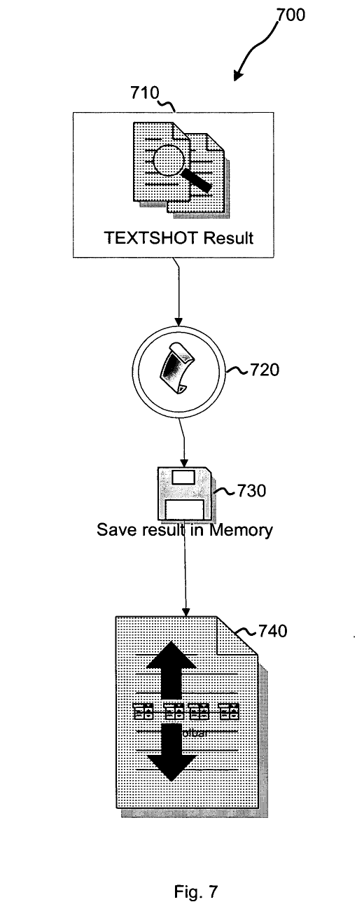

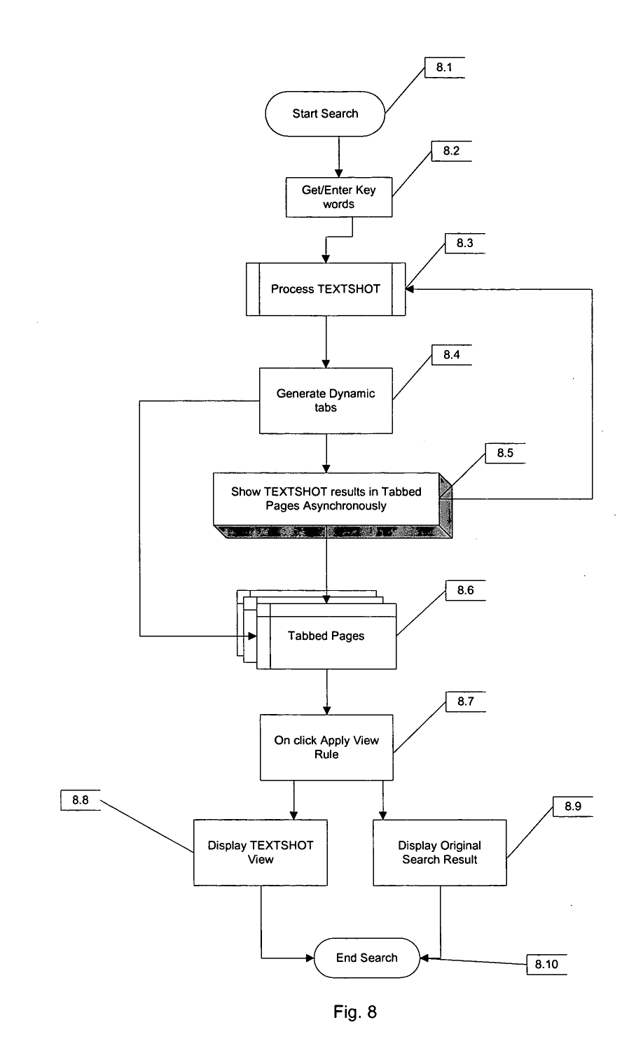

As and when the results are returned, the tabbed pages are dynamically created and populated in a TEXTSHOT web page or search results page. The tabbed pages will be described below in relation to FIGS. 7 and 8.

FIGS. 9A and 9B show where a TEXTSHOT view may be displayed on a results page. For example, in FIG. 9A, a TEXTSHOT view 910 may be shown at the bottom of a results page in a web page 901. Different TEXTSHOT views may be viewed by clicking on one of the TEXTSHOT view links 903, 905, 907 associated with each result returned. Alternatively, as shown in FIG. 9B, the TEXTSHOT view 910′ may be shown immediately after the individual TEXTSHOT view link 903′, 905′, 907′ selected in web page 901′. In other alternative embodiments, the TEXTSHOT view 910 or 910′ may be accessed by clicking on a link to bring it up as an embedded portion of the web page or by mouse-scrolling over the appropriate link.

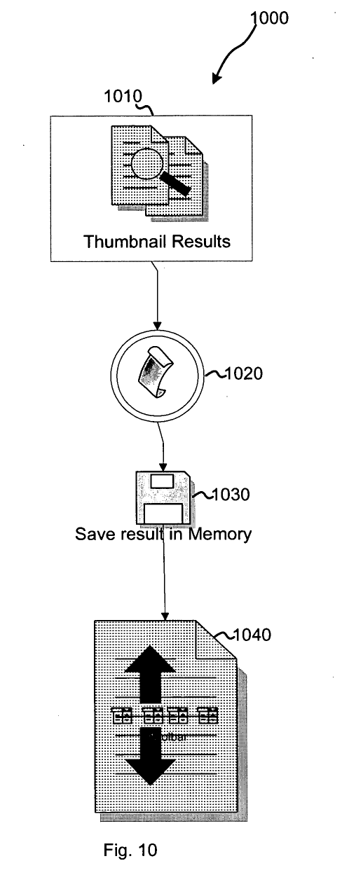

As seen in FIGS. 9A and 9B, a toolbar 912, 912′ is associated with the TEXTSHOT view 910, 910′, respectively. This toolbar is different from the downloadable toolbar that becomes part of the internet browser, which will be described below in relation to FIGS. 10-14. The toolbar 912, 912′ may contain a plurality of buttons that are used to apply certain respective functions to the contents of the TEXTSHOT view 910, 910′. The toolbar buttons and exemplary respective functions may include “search keyword finder” buttons, an “expand” button, a “collapse” button, a “image” button, “zoom-in/zoom-out” buttons, an “original” button, and a “save” button.

“Search Keyword Finder” Buttons:

Depending upon the number of words in the search keywords string, a respective number of dynamic buttons labeled with the respective words and background coloring, as described above, are provided on the left most side of the toolbar. When clicked, these labeled buttons make the search result page scroll to find and display the highlighted preceding instances of the respective keywords in the entire search result page (i.e., the TEXTSHOT view 910, 910′). When the scrolling reaches the last instance of the keyword in the search page and user clicks on the keyword button again, the view goes back again to the very first instance of the keyword in the same search result page and keeps working in this loop-like manner based on user clicks.

Located next to these dynamic buttons, which are labeled with the respective search keywords, another button named “All” may also appears in the toolbar. The function of the button “All” is similar to that of the dynamic buttons, explained above, and when clicked, this button also scrolls the search result page to find and display the highlighted occurrences of the complete search keywords string within the same search result page.

Also when the TextShot is loaded, this function is fired automatically the first time and attempts to locate the complete search keywords. If it cannot find all of the complete search keywords, it attempts to find the first keyword. This process is automated so when the TextShot view loads, the TextShot viewer scrolls directly to the searched keyword(s) and the user instantly see the keyword(s) highlighted with border around the keyword(s).

“Expand” Button:

When a user clicks this button, the TEXTSHOT view 910, 910′ expands, either to the full size of the browser or to a certain percentage of it.

“Collapse” Button:

This button appears when the TEXTSHOT view 910, 910′ is expanded. When the user clicks this button, the TEXTSHOT view 910, 910′ is restored to its original size. Generally, only one of the collapse button and expand button is shown depending on the current view in the TEXTSHOT view.

“Image Version” Button:

When this button is clicked, the web page communicates with the server 114 using XMLHTTP protocol and loads the full original web page to the link in the search results. This web page will contain all of its original content without stripping any tags. The searched keywords may remain highlighted and colored.

“Zoom-In/Zoom-Out” Buttons:

When the Zoom-in button is clicked, the TEXTSHOT view zooms in on the content of the page and keeps increasing the size of the entire displayed content within the TEXTSHOT view 910, 910′ with each click.

When the Zoom-out button is clicked, the TEXTSHOT view does the reverse action to the Zoom-in button and keeps on reducing the size of the entire content in the TEXTSHOT view 910, 910′ with each additional click.

“Original” Button:

This button, when clicked, restores the TEXTSHOT view 910, 910′ to its original size. This button appears when the TEXTSHOT view 910, 910′ has been zoomed in or zoomed out. It can also be used to restore the size of the TEXTSHOT view 910, 910′ to its original shape.

“Save” Button:

This button, when clicked, opens the standard “Save As” dialog box of the Internet Browser, whereby, the user can save the content of the TEXTSHOT view 910, 910′ on the computer or network as an HTML file.

At the bottom of web page 901, 901′ a plurality of numbered tabs 914, 914′ may be displayed. These numbered tabs 914, 914′ allow for navigation between additional search results and will be described further with respect to FIGS. 7 and 8.

Having described the TEXTSHOT view component, the spelling and keywords recommender component will be described in relation to FIGS. 4-6. FIG. 4 shows a second exemplary embodiment of the enhanced interface utility 400. This embodiment is similar to that shown in FIG. 1 except that the spelling and keywords recommender component has been implemented.

As the user types the search keywords in the search keyword box of the web page 410 of the web browser on the user's computer 401, the spelling and keywords recommender component communicates with the server 414 in the background, using XMLHTTP request 416 or other remote scripting via network 418. Before the user starts typing, a client side JavaScript event 412 is triggered to invoke the function to start collecting the recommended spelling. For each word typed or space entered, a XMLHTTP request 416 to the server 414 is made in the background. Alternatively, this function may be set so that it is activated after a certain number of characters are entered, for example 4 characters, or after a certain amount of time passes since the user started typing, for example after one second of typing.

The server-side scripts 420 query the server 414 for recommended keywords 426. If necessary, the server 414 may pass the searched keyword to a third-party system 422 to return the recommended keyword using HTTP Protocols 424 to obtain recommended words. Next, the recommended keywords are collected and sent to the user's web browser using XMLHTTP response 418.

In the web browser on the user's computer 401, client-side scripts 412 are used to print the recommended words on the web page 410 beneath the search input as seen in exemplary screen shot 600 of FIG. 6. As seen in FIG. 6, the user typed the term “tributory” in the search input 610 and the spelling and keywords recommender component suggested “tributary” as the keyword 620. The user can then click on the recommended keywords to insert it automatically to the search field and replace the originally misspelled keywords, and then manually begin searching with the recommended keywords. The user sees the recommended keywords substantially instantaneously, without any reloading of the web page 410 as performed by existing web browsers. The user can then select the recommended keywords to start his search or use the existing typed search terms. In an alternative embodiment, more than one recommended keyword is returned.

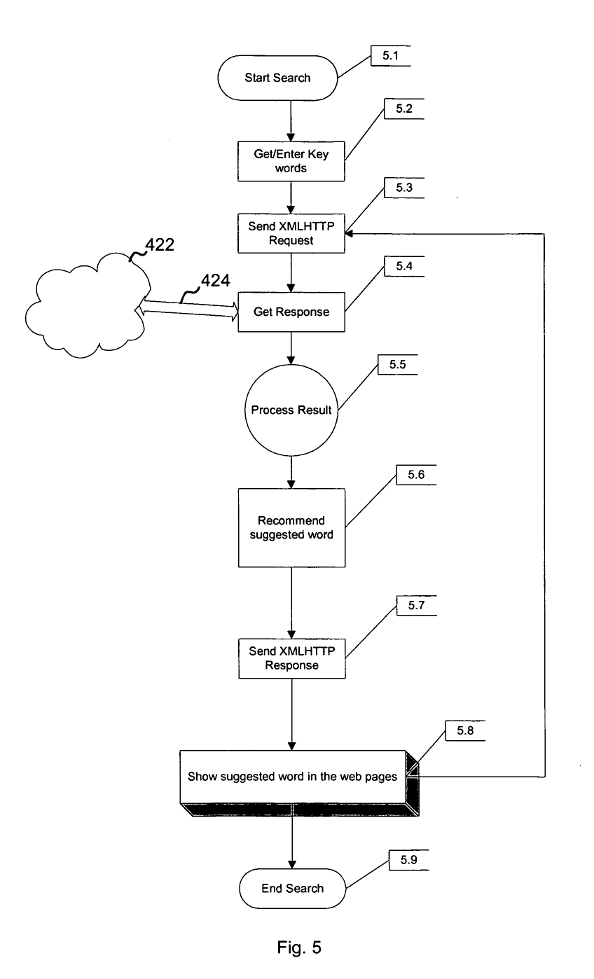

FIG. 5 shows an exemplary embodiment of the data flow for implementing the spelling and keywords recommender component. First, the user starts the search using Internet browser at step 5.1. At step 5.2, the user types the keywords for the search. After each word or portion of word is entered, the client-side script triggers XMLHTTP request to the server at step 5.3.

The server receives responses from its internal database or using HTTP protocol to retrieve results from external search engines or dictionaries 222 at step 5.4 and the server processes the result at step 5.5. From this result, the recommended keyword is retrieved at step 5.6. This is performed by a script on the server, referred to as a keyword guesser, that matches any keyword entered into the search box with a list of keywords the server has in its database using a spelling algorithm. If the keyword guesser find keywords close to the searched term, the server selects the highest ranking keyword, either on a character match basis or on the number that the word has been searched for, and the server returns the highest ranking keyword back to the browser as a recommended keyword. Alternatively, the system may pass the searched keyword to a third-party system to return the recommended keyword. In yet another alternative, the server may return a predetermined number of keywords based on the highest rankings. For example, the server may return the top five highest ranked keywords.

Next, at step 5.7, the keyword is sent in return to a XMLHTTP call by the browser and the browser shows the recommended keywords in the web page substantially instantaneously at step 5.8. The process then loops through steps 5.3 to 5.8 for the next keyword.

Once all recommended keywords have been obtained, the user may proceed with retrieving the appropriate web page and ends the search at step 5.9. Alternatively, if the user does not want to wait for the recommended keywords, the user may proceed with retrieving the appropriate web pages. The results may be displayed with or without the TEXTSHOT view as described above.

The third component of the enhanced interface utility is tabbed paging. Web based client-side tabs are displayed on the search page. These tabbed pages are generated when search results are returned from the server. The number of tabbed pages are dependent on the number of results returned. The tabbed pages are written using JavaScript or DHTML and are generated on the fly. The number of returned results may be distributed equally among the tabs or each tabbed page may have a pre-set limit, such as 3 results per page.

As seen in FIGS. 9A and 9B, clicking on the tabs may generate two kinds of respective views for each tab. Search results view 902, 902′ is generally in the upper half of the browser page 901, 901′ and contains a certain number of the original search result items and the second view is in the lower half of the web page 901, 901′ which may be the TEXTSHOT view 910, 910′. As a default, the TEXTSHOT view 910, 910′ may show the very first item displayed in the search results view 902, 902′ in the upper half of the web page 901, 901′.

Moving between the tabs is instantaneous and does not involve any round trips to the server as all the results are stored temporarily in the browser cache memory. The results are hidden and shown instantly when the tabs are clicked. As seen in exemplary screen shots 901″ and 901′″ of FIGS. 9C and 9D, a user can navigate between search results by clicking on the numbered tabs.

‘Back’ and ‘Forward’ buttons may also be provided on either side of the tabs bar, respectively, to instantly move forward and backward among the tabbed pagination, without going back to the server.

FIG. 7 shows an exemplary embodiment for implementing the tabbed pages component 700. The TEXTSHOT results 710 are collected from the TEXTSHOT process as described above. Based on the number of results returned from the search query, a respective number of tabbed pages are dynamically created on the fly. A client side script 720 collects the dynamically generated pages, which include the search results along with their TEXTSHOT views, from the server and embeds it into the tabbed page and saves the results in the memory of the computer or on the network. The results are then used to generate the tabbed pages in the web page 740. Since the TEXTSHOT pages reside in the client computer's memory, navigating between the tab pages shows the TEXTSHOT pages instantly without the need of making a server request again.

FIG. 8 shows an exemplary embodiment of the data flow for implementing the tabbed paging. The user starts the search using an Internet browser at step 8.1. The user enters the keywords for the search at step 8.2. Optionally, the system may present recommend keywords as described above. At step 8.3, the system processes the TEXTSHOT responses as described above.

At step 8.4, the tabs are generated dynamically. These tabs contain the search results and the TEXTSHOT views. At step 8.5, a client side script collects the results from the server and populates the content into the dynamic tabs. The results may be returned and populated asynchronously.

A calculated number of tabbed pages are generated, based on the number of search results at step 8.6. For example, each tabbed page may contain between 1 and 10 results. It is understood that the number of search results could be adjusted as desired.

Once a user clicks on a tab, a view rule is applied for the respective tab page at step 8.7. For example, the view may be arranged so that the original search results are displayed in the upper half of the browser window and that the TEXTSHOT view is shown in the lower half of the browser window. Alternatively, as described previously, the TEXTSHOT view may be placed beneath the designated TEXTSHOT view link.

At steps 8.8 and 8.9, the original search view and TEXTSHOT view are displayed with the original search view in the upper portion of the web page and the TEXTSHOT view in the lower portion of the web page. Once the user has finished viewing the results, the user may end the search at step 8.10.

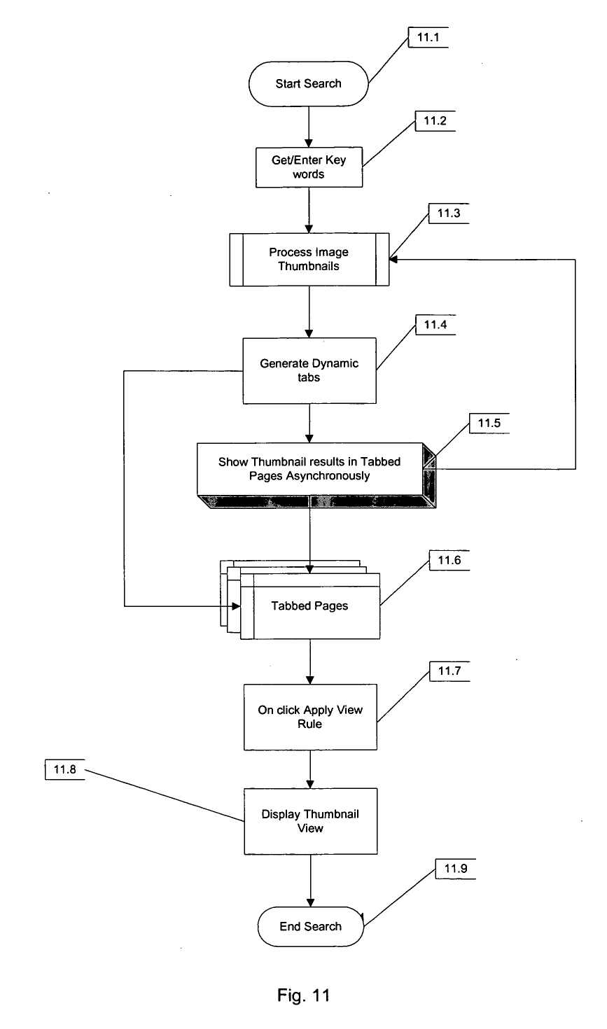

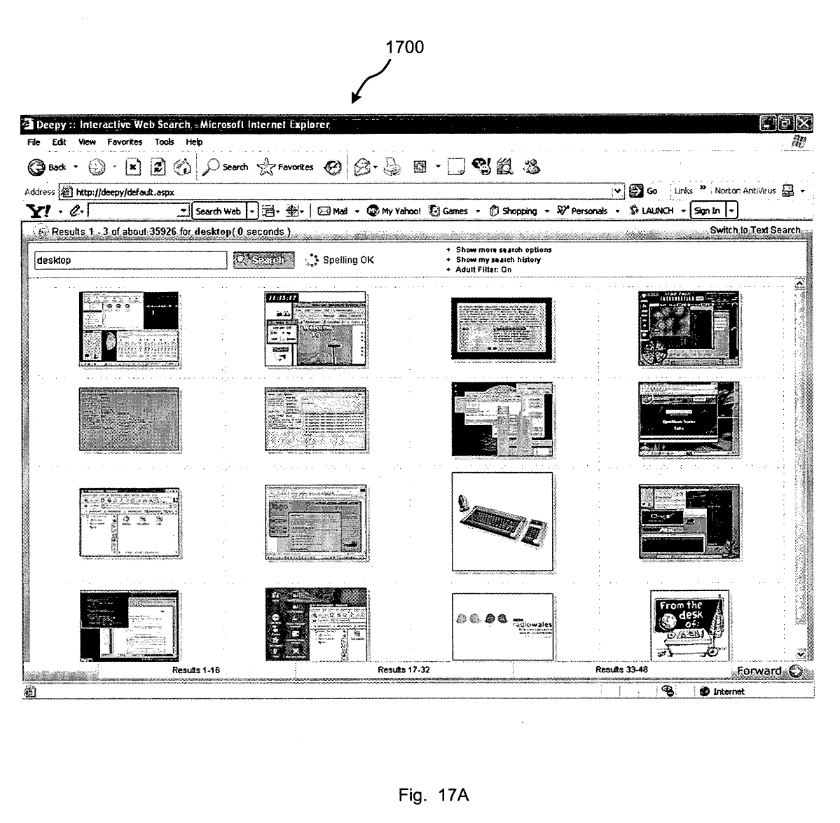

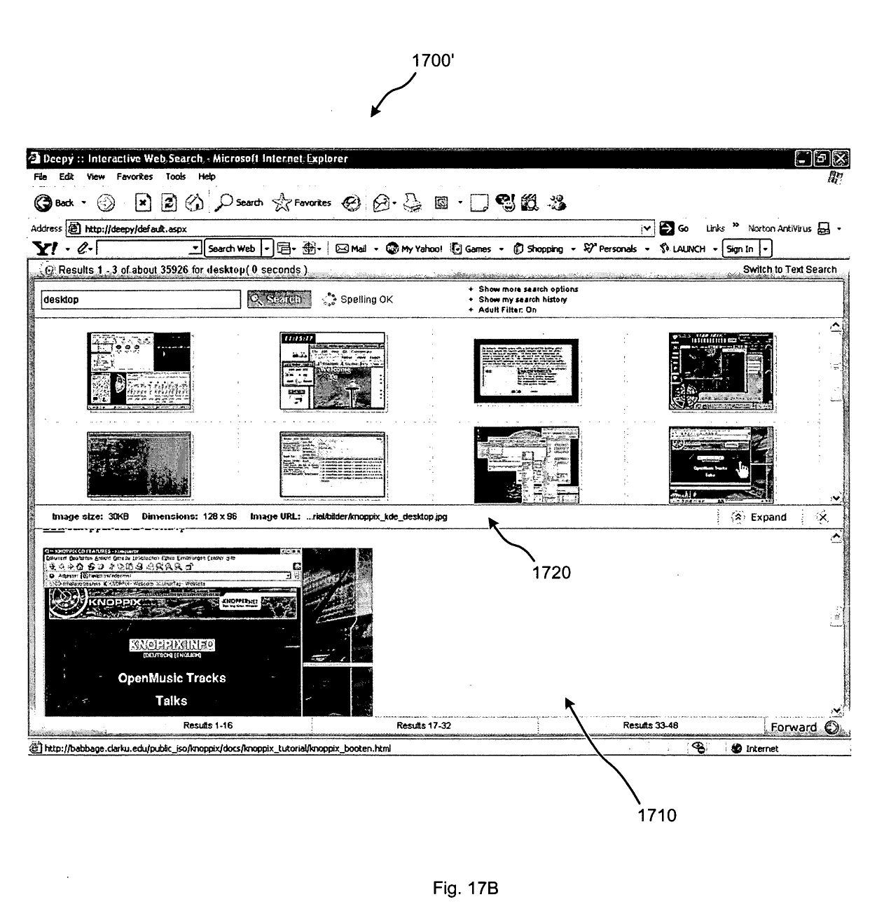

Another component of the enhanced interface utility, as shown in FIGS. 10 and 11 is a tabbed paging system for images. In this component, a user can specifically perform searches for images as shown in FIG. 1. The user conducts a search from a web page, which sends a query using XMLHTTP to a server. An application on the server can then query its database or an external system to search. Once the server receives the results, the server will obtain the image name, image URL, image thumbnail, along with other information. The server then returns the results to the user's web page where a number of thumbnails are displayed for each tab. An exemplary screen shot 1700 is shown in FIG. 17A. The number of thumbnails displayed may vary, for example, twenty or fifty thumbnails. In the screen shot 1700, sixteen images are returned per tabbed page.

The images for each of the tabs are cached so that a user may navigate quickly between them. Depending on the number of tabs shown, the web page may request additional images from the server without needing to perform further searching when a user requests additional images. For example, if three tabs are shown and the user navigates to the next tab using the forward button, then those images are retrieved from the server and shown on the tabbed page.

Once a user clicks on an image, a new frame in the web page is opened displaying the page holding the image. An exemplary screen shot 1700′ is shown in FIG. 17B. In this manner, the information retrieved is quickly displayed for the user. As seen in screen shot 1700′, image preview pane 1710 is displayed in a lower portion of the web browser. A toolbar 1720 is associated with image preview pane 1710. The toolbar 1720 may include various pieces of information including image size, image dimensions, and the URL for the image. The toolbar 1720 may also include an “expand” button which causes the image preview pane 1710 to expand to the full size of the browser and a “collapse” button which restores the image preview pane 1710 to its original size. The image preview pane 1710 can be hidden by clicking a button marked with an “X” to show the full search results page.

FIG. 10 shows an exemplary embodiment for implementing the tabbed pages component 1000 for images. The thumbnail results 1010 are collected from the image retrieval process as described above. Based on the number of results returned from the search query, a respective number of tabbed pages are dynamically created on the fly. A client side script 1020 collects the dynamically generated pages, which include the thumbnail images from the server and embeds them into the tabbed page and saves the results in the memory 1030 of the computer or on the network. The results are then used to generate the tabbed pages in the web page 1040. Since the thumbnail images reside in the client computer's memory, navigating between the tab pages shows the next set of thumbnails instantly without the need of making a server request again. By clicking on the thumbnail image, the image is loaded in a new frame displayed on the same web page.

FIG. 11 shows an exemplary embodiment of the data flow for implementing the tabbed paging for images. The user starts the search using an Internet browser at step 11.1. The user enters the keywords for the search at step 11.2. Optionally, the system may present recommend keywords as described above. At step 11.3, the system processes the thumbnail images as described above.

At step 11.4, the tabs are generated dynamically. These tabs contain the results as thumbnail images. At step 11.5, a client side script collects the results from the server and populates the content into the dynamic tabs. The results may be returned and populated asynchronously.

A calculated number of tabbed pages are generated, based on the number of search results at step 11.6. For example, each tabbed page may contain up to twenty or fifty results. It is understood that the number of search results could be adjusted as desired.

Once a user clicks on a tab, a view rule is applied for the respective tab page at step 11.7. For example, the view may specify the number of thumbnails to supply, the types of information to be supplied with the thumbnail, and link to the image.

At steps 11.8 the thumbnail images are displayed. Once the user has finished viewing the results, the user may end the search at step 11.9.

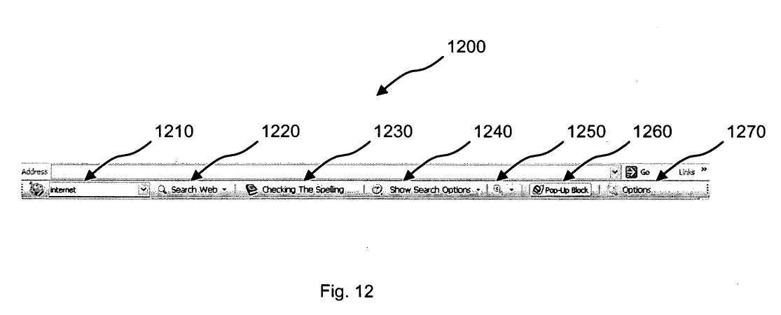

Having described the various components separately, there are at least two approaches for accessing the enhanced interface utility. One approach, as has been described above, is hosting a web page that allows the user to decide whether to search the web or to search only images. The second approach is to provide a search toolbar, which is distinct from the TEXTSHOT view toolbar, that can be downloaded and stored on the user's computer. This search toolbar then appears on a web page whenever the user launches the web browser. The search toolbar 1200, as seen in FIG. 12 has several elements including a search input field 1210, a drop-down menu 1220 to choose between web searching and image searching, a spell checking area 1230, show search options button 1240, a zoom-in/zoom-out button 1250, a pop-up blocker button 1260, an options button 1270, and a new version notifier (not shown). Finally, a system date and time stamp (not shown) can be displayed on the toolbar.

The search input field 1210 may also display a history of searched keywords in a drop-down menu. The menu 1220 used to select between web searching and image searching acts a search button once the user is ready to perform the search.

The spell checking area 1230, which functions as describe above for the spelling and keywords recommender component by being triggered when the user enters a space in the keywords box, once the number of characters being typed in the keywords box reaches 4, or a certain amount of time passed since the user started typing, for example after one second of typing.

The pop-up blocker 1260 is a typical pop-up blocker, that eliminates the browser pop-up windows and stop them before showing on the user screen, and can be enabled by default and when it is clicked for a particular website, the action should disable the pop-up blocker for that particular website.

The ‘Options’ button 1270, which when clicked, opens a window containing the following options:
i. Enable Spellchecker (checked by default);
ii. Clear Search History, which when clicked clears the Search History;
iii. Disable Pop-up Blocker; and
iv. Uninstall.

The ‘New Version Notifier’ is activated when a new version of the toolbar is available. The toolbar communicate with the server periodically, for example once a day, to check if there is a new version or update is available. If there is a new version or update available from the server, it should show a message to the user informing about the availability of the new version or update and include a link to the website where the user can manually do the upgrade.

The search toolbar 1200 has the ability to access the main components of the enhanced utility interface without requiring the user to visit a specific web page. By opening a web browser on the user's computer, the search toolbar 1200 is automatically available to the user. The search toolbar 1200 has the same functionality as the web-hosted service to automatically receive recommended keywords before the user launches the search. Because the search toolbar 1200 is hosted on the user's computer, it has the ability to receive compressed data and to decompress it for display. This allows users with slower connections to the network to perform quick searches.

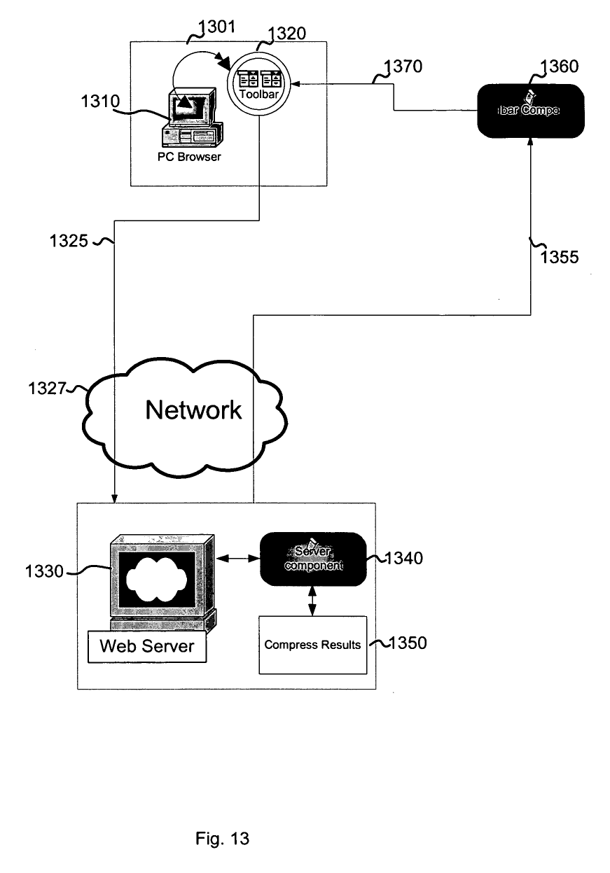

One exemplary embodiment for implementing the search toolbar is shown in FIG. 13. In this exemplary embodiment, a user launches a web-browser 1310 from his computer 1301, which has a search toolbar 1320 imbedded therein. The user types the desired keyword for the search and presses ‘Enter’ to begin the search. The search toolbar 1320 generates a HTTP request 1325 to a server 1330 via a network 1327.

The server 1330 performs various functions via the appropriate server component 1340 as described above for the web generated searching and obtains search results. The information, such as search results and TEXTSHOT views, regarding these results are compressed by a compressing component 1350. The server 1330 returns a HTTP response 1355 with the compressed information to a toolbar component 1360 configured to received the compressed information. The toolbar component 1360 decompresses the information and provides the decompressed results 1370 to the search toolbar 1320, thereby allowing the information to be displayed by the web browser 1310. The search results may be displayed as a TEXTSHOT view or in a conventional manner.

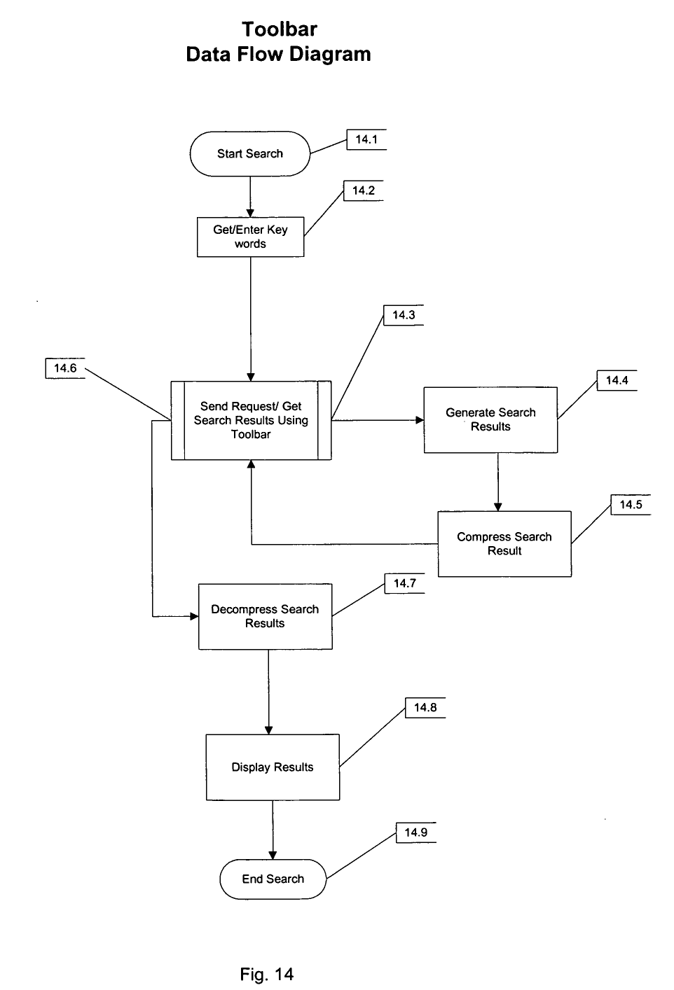

FIG. 14 shows an exemplary embodiment of the data flow for implementing the compression/decompression of the search results. First, a user starts the search using the search toolbar at step 14.1. Next, at step 14.2, the user types the keywords for the search.

The search toolbar sends the request to the server over the internet using HTTP protocol at step 14.3 where the server generates the search results at step 14.4. A compression component of the server compresses the search results using a compression method, such as, Gzip, so that the size of the data is dramatically reduced for quick data transfer over the internet at step 14.5. The search toolbar receives the compressed results via an HTTP response at step 14.6.

Next, at step 14.7, a client side toolbar component of the search toolbar decompresses the search results. The results are displayed in a web page of the web browser at step 14.8.

Finally, the user terminates the search at step 14.9 by exiting the web browser or the search toolbar.

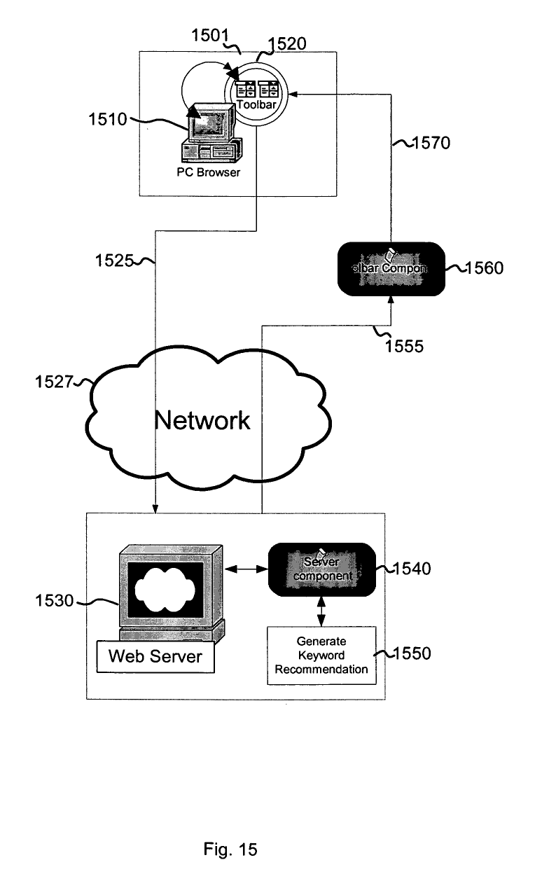

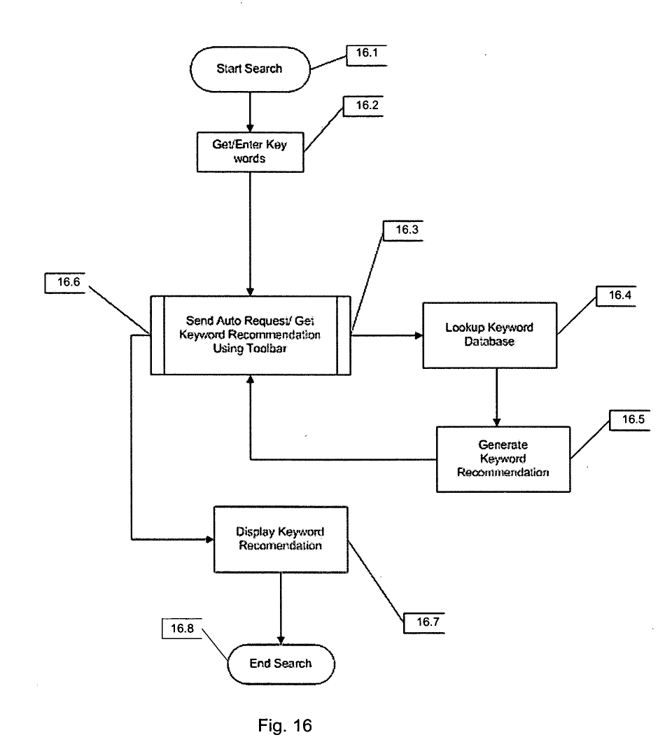

As described above, the search toolbar allows users to take advantage of the enhanced utility interface without having to go to a particular web page to perform the search. FIGS. 15 and 16 show how the search toolbar uses the spelling and keywords recommender component of the enhanced utility interface.

One exemplary embodiment for using the spelling and keywords recommender component with the search toolbar is shown in FIG. 15. In this exemplary embodiment, a user launches a web-browser 1510 from his computer 1501, which has a search toolbar 1520 imbedded therein. As the user types the search keywords in the search toolbar 1520, the search toolbar 1520 communicates with the server 1530 in the background, using an HTTP request 1525 or other remote scripting via network 1527.

The server-side scripts 1540 query the server 1530 for recommended keywords 1550. If necessary, the server 1530 may pass the searched keyword to a third-party system (not shown) to return the recommended keyword using HTTP protocols to obtain recommended words. Next, the recommended keywords are collected and sent via an HTTP response 1555 to a toolbar component 1560 of the search toolbar 1520.

In the web browser on the user's computer 1501, the search toolbar 1520 displays the recommended words on the web page of the web browser 1510. The user can then click on the recommended keywords to begin searching with the recommended keywords. The user sees the recommended keywords substantially instantaneously, without any reloading of the web page of the web browser 1510 as performed by existing web browsers. The user can then select the recommended keywords to start his search or use the existing typed search terms.

FIG. 16 shows an exemplary embodiment of the data flow for implementing the spelling and keywords recommender component. First, the user starts the search using the search toolbar at step 16.1. At step 16.2, the user types the keywords for the search. After each word or portion of word is entered, the search toolbar triggers an HTTP request to the server at step 16.3.

The server receives responses from its internal database or using HTTP protocol to retrieve results from external search engines or dictionaries at step 16.4 and the server processes the result at step 16.5. This is performed substantially as described above with reference to FIG. 5.

Next, at step 16.6, the recommended keyword is sent by the server to the search toolbar via an HTTP response where the search toolbar shows the recommended keywords in the web page substantially instantaneously at step 16.7. The process may then be repeated for the next keyword.

Once all recommended keywords have been obtained, the user may proceed with retrieving the appropriate web page and ends the search at step 16.9. Alternatively, if the user does not want to wait for the recommended keywords, the user may proceed with retrieving the appropriate web pages. The results may be displayed with or without the TEXTSHOT view as described above.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. For example, many requests and responses have been described as being in an XMLHTTP format or HTTP format, but it is understood that many other formats could be used. In addition, several references to scripts have been described as JavaScripts, but it is understood that there are many different varieties of programming languages or code, such as DHTML,C++, that could be used to perform the desired functions. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for searching the world wide web comprising:
(a) receiving one or more keywords for a search;
(b) executing a search of the world wide web based on the one or more keywords to identify one or more web pages relevant to one or more keywords;
(c) creating text versions of the one or more web pages by removing images from the one or more web pages;
(d) providing access to the text version of the one or more web pages; and
(e) displaying the text version of one of the web pages.

2. The method according to claim 1, wherein creating text versions of the one or more web pages includes applying tag manipulation rules to each of the one or more web pages.

3. The method according to claim 2, wherein applying said tag manipulation rules includes removing all images contained in each of said one or more web pages.

4. The method according to claim 2, wherein applying said tag manipulation rules includes comparing tags in each of said one or more web pages to a predefined list of tags and retaining text associated with any of the predefined list of tags in each of the one or more web pages results are retained and removing the tags associated with any of the predefined list of tags.

5. The method according to claim 2, wherein applying said tag manipulation rules includes comparing tags in each of said one or more web pages to a predefined list of allowed tags and retaining the tags associated with the predefined list of tags.

6. The method according to claim 1, wherein displaying the text view of one of the web pages includes displaying a link for each of said one or more web pages in a first portion and displaying the text view of one of the web pages associated with one of the links of the one or more web pages in a second portion, wherein selecting a different link displays a different text version of a different one of the web pages associated with the different link in the second portion.

7. The method according to claim 1, wherein displaying the text version of one of the web pages includes providing a plurality of tabbed pages, each tabbed page having a first portion and a second portion, said first portion being configured to display a predetermined number of links of the one or more web pages, the second portion displaying the text version of one of the web pages associated with one of the number of links in said first portions, wherein selecting a different link displays a different text version of a different one of the web pages associated with the different link in the second portion.

8. The method according to claim 7, wherein selecting another of the plurality of tabbed pages displays a different set of links of the one or more web pages.

9. The method according to claim 1, recommending a keyword prior to performing the query.

10. The method according to claim 9, wherein recommending the keyword includes receiving at least a portion of the keyword, performing a look-up based on at least a portion of the keyword, and returning a recommended keyword.

11. The method according to claim 10, using the recommended keyword as one of the one or more keywords for the search.

12. The method according to claim 1, wherein the one or more keywords are provided from a web browser.

13. The method according to claim 1, wherein the one or more keywords are provided from a search toolbar.

14. The method according to claim 1, further comprising storing the text version of the one or more web pages in a cache.

15. The method according to claim 14, wherein providing access to the text version of one of the web pages includes accessing the text version of the one or more web pages in the cache.

16. A system for searching the world wide web, the system comprising:
a server configured to receive one or more keywords for a search, to execute a search of the world wide web based on the one or more keywords to identify one or more web pages relevant to one or more keywords, to create text versions of the one or more web pages by removing images from the one or more web pages, to provide access to the text version of the one or more web pages, and to transmit information to display the text version of one of the web pages.

17. The system according to claim 16, wherein the server is configured to create text versions of the one or more web pages by applying tag manipulation rules to each of the one or more web pages.

18. The system according to claim 17, wherein applying said tag manipulation rules includes removing all images contained in each of said one or more web pages.

19. The system according to claim 17, wherein applying said tag manipulation rules includes comparing tags in each of said one or more web pages to a predefined list of tags and retaining text associated with any of the predefined list of tags in each of said one or more web pages results are retained and removing the tags associated with any of the predefined list of tags.

20. The system according to claim 17, wherein applying said tag manipulation rules includes comparing tags in each of said one or more web pages to a predefined list of allowed tags and retaining the tags associated with the predefined list of tags.

21. The system according to claim 16, wherein the transmitted information to display the text version of one of the web pages includes information to display a link for each of the one or more web pages in a first portion and to display the text view of one of the web pages associated with one of the links of the one or more web pages in a second portion, wherein selecting a different link displays a different text version of a different one of the web pages associated with the different link in the second portion.

22. The system according to claim 16, wherein the transmitted information to display the text version of one of the web pages includes information to provide a plurality of tabbed pages, each tabbed page having a first portion and a second portion, the first portion being configured to display a predetermined number of links of the one or more web pages, the second portion being configured to display the text version of one of the web pages associated with one of the number of links in said first portions, wherein selecting a different link displays a different text version of a different one of the web pages associated with the different link in the second portion.

23. The system according to claim 22, wherein selecting another of the plurality of tabbed pages displays a different set of links of the one or more web pages.

24. The system according to claim 16, wherein the server recommends a keyword prior to performing the query.

25. The system according to claim 24, wherein the server receives at least a portion of the keyword, performs a look-up based on at least a portion of the keyword, and returns a recommended keyword.

26. The system according to claim 24, wherein the server receives the recommended keyword as one of the one or more keywords for the search.

27. The system according to claim 16, wherein the one or more keywords are provided from a web browser.

28. The system according to claim 16, wherein the one or more keywords are provided from a search toolbar.

29. The system according to claim 16, wherein the server is configured to execute a search of the world wide web based on the one or more keywords to identify one or more images relevant to one or more keywords, to create a thumbnail versions of the one or more web images; and to transmit information for displaying the thumbnail image associated with each of said one or more images.

30. The system according to claim 29, wherein the transmitted information includes information to provide a plurality of tabbed pages, each tabbed page is configured to display a predetermined number of links and their associated thumbnail images, and selecting one of the predetermined number of links or thumbnail image associated with the one of the predetermined number of links displays the image.

31. The system according to claim 30, wherein selecting another of the plurality of tabbed pages displays a different set of links and their associated thumbnail images.

32. A method for searching the world wide web for images, the method comprising:
(a) receiving one or more keywords for a search;
(b) executing a search of the world wide web based on the one or more keywords to identify one or more images relevant to one or more keywords;
(c) creating a thumbnail version of the one or more web images; and
(d) displaying the thumbnail image associated with each of said one or more images, wherein displaying the thumbnail images includes providing a plurality of tabbed pages, each tabbed page configured to display a predetermined number of links and their associated thumbnail images, wherein selecting one of the predetermined number of links or thumbnail image associated with the one of the predetermined number of links displays the image.

33. The method according to claim 31, wherein selecting another of the plurality of tabbed pages displays a different set of links of the thumbnail images.

34. An interface utility for searching the world wide web, the interface utility comprising:
(a) a text view component configured to display in a web page a text version of an individual search result returned by a search engine; and
(b) a tabbed page component, the tabbed page component comprising at least one tabbed page configured to provide a plurality of search results returned by the search engine, wherein one of the plurality of search results includes the individual search result displayed by the text view component.

35. The interface utility according to claim 33, further comprising a spell recommender component configured to return recommended search terms based on search terms provided by a user before searching the world wide web.

36. The interface utility according to claim 33, wherein the text view component includes a server configured to receive keyword requests from a user and perform a search on the search engine.

37. The interface utility according to claim 35, wherein the server manipulates the individual search results by applying tag manipulation rules to the individual search results.

38. The interface utility according to claim 36, wherein the tag manipulation rules include removing all images contained in each of the individual search results.

39. The interface utility according to claim 36, wherein the tag manipulation rules include a predefined list of tags and text associated with any of the predefined list of tags in each of the individual search results are retained and the tags are removed.

40. The interface utility according to claim 36, wherein the tag manipulation rules include a predefined list of allowed tags that are retained by the individual search results.

41. The method according to claim 9, wherein recommending a keyword prior to performing the query includes recommending a plurality of keywords for at least one of the one or more keywords.

42. The system according to claim 24, wherein the server recommends a plurality of keywords for at least one of the one or more keywords.
